(19) United States
(12) Patent Application Publication
(10) Pub. No.: US 2025/0084507 A1
(43) Pub. Date: Mar. 13, 2025

(54) HYDROGEN STORAGE ALLOY, HYDROGEN OCCLUDING METHOD, HYDROGEN RELEASING METHOD, AND POWER GENERATING SYSTEM

(71) Applicants: SHIMIZU CORPORATION, Tokyo (JP); NATIONAL INSTITUTE OF ADVANCED INDUSTRIAL SCIENCE AND TECHNOLOGY, Tokyo (JP)

(72) Inventors: Yuta SEGAWA, Tokyo (JP); Eisuke SHIMODA, Tokyo (JP); Naruki ENDO, Koriyama-shi (JP); Tetsuhiko MAEDA, Koriyama-shi (JP); Kiyotaka GOSHOUME, Koriyama-shi (JP)

(73) Assignees: SHIMIZU CORPORATION, Tokyo (JP); NATIONAL INSTITUTE OF ADVANCED INDUSTRIAL SCIENCE AND TECHNOLOGY, Tokyo (JP)

(21) Appl. No.: 18/687,466

(22) PCT Filed: Aug. 31, 2022
(86) PCT No.: PCT/JP2022/032849

§ 371 Date: Feb. 28, 2024

(30) Foreign Application Priority Data
Sep. 1, 2021 (JP) 2021-142329

(51) Int. Cl. C22C 14/00; C22C 30/00; H01M 8/065

(52) U.S. Cl. CPC C22C 14/00; C22C 30/00; H01M 8/065; C22C 2202/04

(57) ABSTRACT

This hydrogen storage alloy has a composition represented by a general formula Ti₁FeₓMn_{y}Nb_{z} (0.804<x≤0.941, 0.033≤y≤0.136, 0<z≤0.081).

### CROSS-REFERENCE TO RELATED APPLICATIONS

This application claims priority based on PCT Patent Application No. PCT/JP2022/032849, filed on Aug. 31, 2022, whose priority is claimed on Japanese Patent Application No. 2021-142329, filed Sep. 1, 2021, the entire content of which are hereby incorporated by reference.

### BACKGROUND

### Technical Field

The present invention relates to a hydrogen storage alloy, a hydrogen releasing method, a hydrogen occluding method, and a power generating system.

### Background Art

Hydrogen does not release carbon dioxide and is thus gaining attention as an environment-friendly fuel. However, hydrogen is a gas at normal temperature and thus has a problem with the storage method. A method in which hydrogen is compressed at a high pressure and stored with a reduced volume has a problem with stability. In addition, in the case of a method in which the volume is reduced by liquefaction, an extremely low liquefaction temperature is a hindrance.

As one storage means for safely and conveniently handling hydrogen in a volume density that is the volume density of liquid hydrogen or higher, a method in which a hydrogen storage alloy allowing hydrogen to be put thereinto and saved is used can be exemplified.

As the hydrogen storage alloy, for example, a titanium-iron-vanadium hydrogen occluding ternary alloy is known (for example, refer to Patent Document 1).

Patent Document 2 and Patent Document 3 describe titanium-based hydrogen storage alloys represented by a rational formula Ti₁₊ₖAFe₁₋₁Mn₁Aₘ(here, 0≤k≤0.3, 0<1≤0.3, 0<m≤0.1, A is an element composed of at least one of niobium and a rare earth element).

### CITATION LIST

### Patent Document

### Patent Document 1

Japanese Unexamined Patent Application, First Publication No. 2004-43945

### Patent Document 2

Japanese Unexamined Patent Application, First Publication No. S61-250136

### Patent Document 3

Japanese Unexamined Patent Application, First Publication No. S62-27301

### SUMMARY OF INVENTION

### Technical Problem

The pressure upper limit that is not designated for high-pressure gases in Japan's High Pressure Gas Safety Act is 1.1 MPa (abs). Therefore, the pressure of hydrogen (hydrogen pressure) at the time of occluding hydrogen in a hydrogen storage alloy needs to be set to lower than 1.1 MPa.

On the other hand, in order to release hydrogen from a hydrogen storage alloy, a hydrogen pressure that is equal to or higher than the atmospheric pressure of 0.1 MPa (abs) is required. “abs” indicates absolute pressures.

Therefore, the amount of hydrogen that can be taken in and out between 0.1 MPa (abs) and 1.1 MPa (abs) is an ordinary effective hydrogen storage amount.

As an important usage of hydrogen storage alloys, the use as a hydrogen supply source for fuel cells that generate power using hydrogen as a fuel can be exemplified.

In a case where hydrogen is supplied to a fuel cell, particularly, in a case where hydrogen is supplied to a high-output fuel cell, a pressure loss in a pipe or the like cannot be ignored. Therefore, the pressure of hydrogen that is released from a hydrogen storage alloy (hydrogen pressure) slightly exceeding the atmospheric pressure of 0.1 MPa (abs) is not sufficient. In order to maintain a flow rate of hydrogen necessary for high-output fuel cells, a hydrogen pressure of 0.2 MPa (abs) or higher is required.

That is, in a case where hydrogen is supplied to a fuel cell, the amount of hydrogen that can be taken in and out between 0.2 MPa (abs) and 1.1 MPa (abs) is the effective hydrogen storage amount.

However, conventional hydrogen supply alloys have not yet been sufficiently studied from the viewpoint of supplying hydrogen to fuel cells, and the effective hydrogen storage amounts at the time of supplying hydrogen to fuel cells have not been sufficient. Particularly, in a case where the hydrogen storage amount became small, it was difficult to maintain a necessary hydrogen pressure.

In order to increase the effective hydrogen storage amount, an increase in the heating temperature during hydrogen release can be considered. However, a large amount of energy is required for heating in this case.

The present invention has been made in consideration of the aforementioned circumstance, and an object of the present invention is to provide a hydrogen storage alloy, a hydrogen occluding method, a hydrogen releasing method and a power generating system that are capable of increasing the effective hydrogen storage amount in a hydrogen pressure range of 0.2 MPa (abs) or higher and lower than 1.1 MPa (abs).

### Solution to Problem

In order to achieve the aforementioned objects, the present invention employed the following configurations.

[1]A hydrogen storage alloy having a composition represented by a general formula Ti₁FeₓMn_{y}Nb_{z} (0.804<x≤0.941, 0.033≤y≤0.136, 0<z≤0.081).

[2]A hydrogen storage alloy having a composition represented by a general formula Ti₁FeₓMn_{y}Nb_{z} (0.822<x≤0.941, 0.033≤y≤0.136, 0.024<z≤0.081).

[3] The hydrogen storage alloy according to [1] or [2], in which, in the general formula Ti₁FeₓMn_{y}Nb_{z}, 0.8≤x+y+z≤1.2.

[4]A hydrogen occluding method, in which hydrogen having a hydrogen pressure of lower than 1.1 MPa (abs) is occluded into the hydrogen storage alloy according to any one of [1] to [3].

[5] The hydrogen occluding method according to [4], in which the hydrogen is occluded at a hydrogen storage alloy temperature of 40° C. or lower.

[6]A hydrogen releasing method in which hydrogen having a hydrogen pressure of 0.2 MPa (abs) or higher and lower than 1.1 MPa (abs) is released from the hydrogen storage alloy according to any one of [1] to [3] occluding hydrogen at a hydrogen pressure of lower than 1.1 MPa (abs).

[7] The hydrogen releasing method according to [6], in which, in response to a decrease in the hydrogen pressure in association with the hydrogen release, the hydrogen storage alloy is heated, and the hydrogen pressure is held at 0.2 MPa (abs) or higher.

[8] The hydrogen releasing method according to [7], in which the hydrogen is released at a hydrogen storage alloy temperature of 40° C. or higher.

[9]A power generating system including a fuel cell that generates power using hydrogen as a fuel and a fuel tank that supplies hydrogen to the fuel cell, in which the fuel tank is filled with the hydrogen storage alloy according to any one of [1] to [3].

[10] The power generating system according to [9], in which an output of the fuel cell is 10 kW or higher.

### Advantageous Effects of Invention

According to the hydrogen storage alloy, the hydrogen occluding method, and the hydrogen releasing method of the present invention, it is possible to increase the effective hydrogen storage amount in a hydrogen pressure range of 0.2 MPa (abs) or higher and lower than 1.1 MPa (abs). According to the power generating system of the present invention, even when a high-output fuel cell is used, a pipe pressure loss is less likely to be caused, and the power generating system can be operated by slight heating.

### BRIEF DESCRIPTION OF DRAWINGS

FIG. 1 is a schematic configuration view of a power generating system according to one embodiment of the present invention.

FIG. 2 is a PCT curve of a hydrogen storage alloy of Example 1.

FIG. 3 is a PCT curve of a hydrogen storage alloy of Example 2.

FIG. 4 is a PCT curve of a hydrogen storage alloy of Example 3.

FIG. 5 is a PCT curve of a hydrogen storage alloy of Example 4.

FIG. 6 is a PCT curve of a hydrogen storage alloy of Example 5.

FIG. 7 is a PCT curve of a hydrogen storage alloy of Example 6.

FIG. 8 is a PCT curve of a hydrogen storage alloy of Example 7.

### DESCRIPTION OF EMBODIMENTS

Hereinafter, a hydrogen storage alloy according to an embodiment of the present invention, a hydrogen occluding method, a hydrogen releasing method, and a power generating system in which the hydrogen storage alloy is used will be described.

The present embodiment is a specific description for better understanding of the purport of the present invention and does not limit the present invention unless particularly otherwise designated.

In the present specification and claims, “to” used to indicate numerical ranges means that numerical values before and after “to” are included as the lower limit value and the upper limit value.

### [Hydrogen Storage Alloy]

A hydrogen storage alloy according to the present embodiment has a composition represented by a general formula TiFeₓMn_{y}Nb_{z} (0.804<x≤0.941, 0.033≤y≤0.136, 0<z≤0.081). That is, the hydrogen storage alloy according to the present embodiment is a quaternary alloy composed of titanium (Ti), iron (Fe), manganese (Mn) and niobium (Nb).

In the hydrogen storage alloy according to the present embodiment, in a case where the number of titanium atoms is set to 1, the ratio of the number of iron atoms to the number of titanium atoms is more than 0.804 and 0.941 or less, the ratio of the number of manganese atoms thereto is 0.033 or more and 0.136 or less, and the ratio of the number of niobium atoms thereto is more than 0 and 0.081 or less.

In the general formula TiFeₓMn_{y}Nb_{z}, it is preferable that 0.822<x≤0.941, 0.033≤y≤0.136, and 0.024<z≤0.081 are satisfied.

That is, in the hydrogen storage alloy according to the present embodiment, in a case where the number of titanium atoms is set to 1, it is preferable that the ratio of the number of iron atoms to the number of titanium atoms is 0.822 or more and 0.941 or less, the ratio of the number of manganese atoms is 0.033 or more and 0.136 or less, and the ratio of the number of niobium atoms is 0.024 or more and 0.081 or less.

In the general formula TiFeₓMn_{y}Nb_{z}, 0.8<x+y+z≤1.2 is preferable, and 0.9<x+y+z≤1.1 is more preferable.

That is, in a case where the number of titanium atoms is set to 1, the ratio of the total number of iron atoms, manganese atoms and niobium atoms to the number of titanium atoms is preferably 0.8 or more and 1.2 or less and more preferably 0.9 or more and 1.1 or less.

The hydrogen storage alloy according to the present embodiment is capable of sufficiently occluding hydrogen at a hydrogen storage alloy temperature of 40° C. or lower, preferably 30° C. or lower and more preferably 20° C. or lower.

The hydrogen storage alloy according to the present embodiment has a hydrogen releasing pressure of 0.2 MPa or higher even in a case where the hydrogen storage amount is small due to heating at a relatively low temperature of approximately 40° C. to 60° C. and is capable of sufficiently supplying hydrogen to high-output fuel cells.

The hydrogen storage alloy according to the present embodiment includes no rare earth metals and thus can be produced at a low cost.

### [Hydrogen Occluding Method]

A hydrogen occluding method according to the present embodiment is a method in which hydrogen is occluded into the hydrogen storage alloy according to the present embodiment at a pressure of lower than 1.1 MPa (abs).

The pressure of lower than 1.1 MPa (abs) is not designated as a high pressure gas in the High Pressure Gas Safety Act, and it is thus convenient to handle hydrogen at this pressure.

The hydrogen pressure after the occlusion of hydrogen is completed by the hydrogen occluding method according to the present embodiment is not particularly limited as long as the hydrogen pressure is lower than 1.1 MPa (abs). In order to increase the hydrogen storage amount, it is preferable to occlude hydrogen until immediately before the hydrogen pressure after the occlusion of hydrogen is completed reaches 1.1 MPa (abs).

In the hydrogen occluding method according to the present embodiment, it is preferable to occlude hydrogen with the hydrogen storage alloy temperature set to 40° C. or lower. When the hydrogen storage alloy temperature is 40° C. or lower, it is possible to control the hydrogen storage alloy temperature by heat exchange with an external air throughout the year.

Furthermore, hydrogen is preferably occluded at a hydrogen storage alloy temperature of 30° C. or lower and more preferably occluded at a hydrogen storage alloy temperature of 20° C. or lower. As the hydrogen storage alloy temperature at the time of occluding hydrogen becomes lower, the hydrogen pressure can be further decreased, and it is thus possible to further increase the hydrogen storage amount.

After the occlusion of hydrogen is completed by the hydrogen occluding method according to the present embodiment, there is a need to control the temperature to prevent the hydrogen pressure from reaching 1.1 MPa (abs) or higher due to an increase in the hydrogen storage alloy temperature until the occluded hydrogen is released.

Particularly, in a case where hydrogen is occluded until immediately before the hydrogen pressure reaches 1.1 MPa (abs), there is a need to control the temperature to prevent the hydrogen storage alloy from reaching the temperature at the time of occlusion or higher until the occluded hydrogen is released.

### [Hydrogen Releasing Method]

A hydrogen releasing method according to the present embodiment is a method in which hydrogen is released from the hydrogen storage alloy according to the present embodiment having occluded hydrogen at a hydrogen pressure of lower than 1.1 MPa (abs) at a hydrogen pressure of 0.2 MPa (abs) or higher and lower than 1.1 MPa (abs).

The hydrogen storage alloy according to the present embodiment having occluded hydrogen at a hydrogen pressure of lower than 1.1 MPa (abs) is obtained by the hydrogen occluding method according to the present embodiment.

At a hydrogen pressure of 0.2 MPa (abs) or higher, it is possible to sufficiently supply hydrogen to high-output fuel cells.

In the hydrogen releasing method according to the present embodiment, hydrogen release may be ended before the hydrogen pressure reaches 0.2 MPa (abs) to perform the next-time hydrogen occluding method, but it is preferable to release hydrogen until the hydrogen pressure reaches 0.2 MPa (abs) or until immediately before the hydrogen pressure reaches 0.2 MPa (abs) and then perform the next-time hydrogen occluding method. This makes it possible to effectively use the occluded hydrogen.

In the hydrogen releasing method according to the present embodiment, in response to a decrease in the hydrogen pressure in association with hydrogen release, it is preferable to heat the hydrogen storage alloy and hold the hydrogen pressure at 0.2 MPa (abs) or higher. At the time of initiating hydrogen release, the hydrogen pressure sufficiently exceeds a hydrogen pressure of 0.2 MPa (abs), and there is thus no need to heat the hydrogen storage alloy. For example, in a case where hydrogen has been occluded at a hydrogen storage alloy temperature of 20° C., hydrogen may be released at the current temperature, that is, the hydrogen storage alloy temperature of 20° C.

When hydrogen release proceeds, the hydrogen pressure decreases, and the hydrogen storage alloy is thus heated so as to hold the hydrogen pressure of 0.2 MPa (abs).

The heating may be performed at a possible lowest temperature high enough to hold the hydrogen pressure of 0.2 MPa (abs). This makes it possible to save energy for heating. It is also preferable to set the heating temperature to a somewhat higher temperature than the possible lowest temperature high enough to hold the hydrogen pressure of 0.2 MPa (abs) in consideration of the error or the like of the temperature control.

As an energy source for heating, waste heat from a fuel cell, waste heat from a building, a heat storage tank that is installed in the building or the like can be used.

### [Effective Hydrogen Storage Rate]

The effective hydrogen storage amount of the hydrogen storage alloy is obtained as an effective hydrogen storage rate from a PCT curve (hydrogen occluding and releasing characteristics) that is obtained according to JIS H 7201: 2007 “Method for measurement of pressure-composition-temperature (PCT) relations of hydrogen absorbing alloys.”

As shown in examples to be described below, the PCT curve is a curve showing the relationship between the hydrogen storage rate (horizontal axis) and the hydrogen pressure (vertical axis) at the time of occluding and releasing hydrogen. In the PCT curve, the hydrogen storage rate is indicated by the ratio “H/H” of the number of hydrogen atoms to the number of metal atoms (the total number of Ti, Fe, Mn, and Nb). The PCT curve has hysteresis characteristics in which the occlusion pressure and the release pressure are different from each other at each temperature.

The effective hydrogen storage amount assuming the case of supplying hydrogen to a fuel cell is the amount of hydrogen that can be taken in and out between hydrogen pressures of 0.2 MPa (abs) and 1.1 MPa (abs). The effective hydrogen storage rate assuming the case of supplying hydrogen to a fuel cell can be obtained as a difference between the hydrogen storage rate of an occlusion curve at a hydrogen pressure of 1.1 MPa (abs) under the temperature condition at the time of occlusion and the hydrogen storage rate of a release curve at a hydrogen pressure of 0.2 MPa (abs) under the maximum temperature condition at the time of release.

According to the hydrogen storage alloy of the present embodiment, an excellent effective hydrogen storage amount can be obtained. From the viewpoint of increasing the effective hydrogen storage amount, hydrogen is preferably occluded at a hydrogen storage alloy temperature of 20° C. or lower and released at a hydrogen storage alloy temperature of 40° C. or higher and more preferably occluded at a hydrogen storage alloy temperature of 20° C. or lower and released at a hydrogen storage alloy temperature of 50° C. or higher.

### [Power Generating System]

A power generating system according to the present embodiment includes a fuel cell that generates power using hydrogen as a fuel and a fuel tank that supplies hydrogen to the fuel cell. The present power generating system preferably further includes a hydrogen production device that supplies hydrogen to the fuel tank.

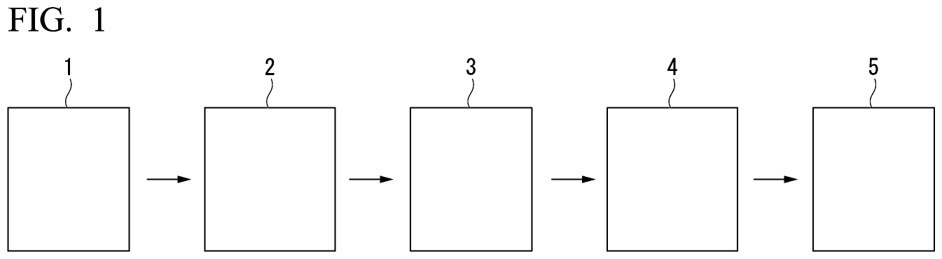

FIG. 1 shows an embodiment of the present power generating system. As shown in FIG. 1, the power generating system according to the present embodiment includes a hydrogen production device 2, a fuel tank 3 and a fuel cell 4. Hydrogen is supplied to the fuel tank 3 from the hydrogen production device 2. Hydrogen that is released from the fuel tank 3 is supplied to the fuel cell 4. From the fuel cell 4, electricity is supplied to an electricity consumer 5.

The fuel tank 3 is filled with the hydrogen storage alloy according to the present embodiment. The specific configuration or specification of the fuel cell 4 is not particularly limited, but a fuel cell with an output of 10 kW or higher can be suitably applied to the present power generating system.

To the hydrogen production device 2, electricity is supplied from an electricity supply source 1. The electricity supply source 1 is not particularly limited, but a power generating facility using a renewable energy, such as a solar cell, is preferably used since the environmental load is curbed and such a power generating facility is environment-friendly.

In the power generating system according to the present embodiment, the fuel tank 3 is filled with the hydrogen storage alloy according to the present embodiment. Therefore, even when a high-output fuel cell is used, a pipe pressure loss is less like to be caused, and the power generating system can be operated by slight heating.

### EXAMPLES

Hereinafter, the present invention will be more specifically described using examples and comparative examples, but the present invention is not limited to the following examples.

In the following examples, Examples 1 and 2 are comparative examples, and Examples 3 to 7 are examples.

### [Element Composition]

The element composition in each example was obtained using a wavelength dispersive fluorescence X-ray spectrometer (trade name: ZSX Primus II, manufactured by Rigaku Corporation). The element compositions of Example 2, Example 5 and Example 6 are not measured.

Table 1 shows element fractions intended upon raw material formulation of each example, element analysis results (atom %) obtained with the wavelength dispersive fluorescence X-ray spectrometer and element analysis results (atom fractions) calculated from these element analysis results (atom %).

### [Effective Hydrogen Storage Rate]

Regarding a hydrogen storage alloy of each example, a PCT curve was obtained according to JIS H 7201: 2007 “Method for measurement of pressure-composition-temperature (PCT) relations of hydrogen absorbing alloys.”

Regarding each example, a hydrogen storage rate [X₂₀] at a hydrogen pressure of 1.1 MPa (abs) in an occlusion curve at 20° C., a hydrogen storage rate [X₄₀] at a hydrogen pressure of 0.2 MPa (abs) in a release curve at 40° C., and a hydrogen storage rate [X₅₀] at a hydrogen pressure of 0.2 MPa (abs) in a release curve at 50° C. were obtained.

In addition, an effective hydrogen storage rate [A₄₀] in a case where the maximum temperature at the time of release was 40° C. and an effective hydrogen storage rate [A₅₀] in a case where the maximum temperature at the time of release was 50° C. were obtained based on the following formulae in each example.

[A₄₀]=[X₂₀]−[X₄₀]

[A₅₀]=[X₂₀]−[X₅₀]

In addition, regarding the effective hydrogen storage rates [A₄₀] and the effective hydrogen storage rates [A₅₀] of Examples 2 to 7, differences from those of Example 1 were each obtained as [ΔA₄₀] or [ΔA₅₀]. The results of each example are shown in Table 2.

### Example 1

Metals that served as raw materials were dissolved by a high-frequency dissolution method so that the composition became TiFe_{0.80}Mn_{0.20}Nb_{0.00} in terms of the atom fractions, thereby obtaining an alloy ingot. Specifically, metals that served as raw materials were thermally treated in an argon atmosphere at a temperature of 1000° C. or higher and 1200° C. or lower for 24 hours or longer and 96 hours or shorter to obtain an alloy ingot.

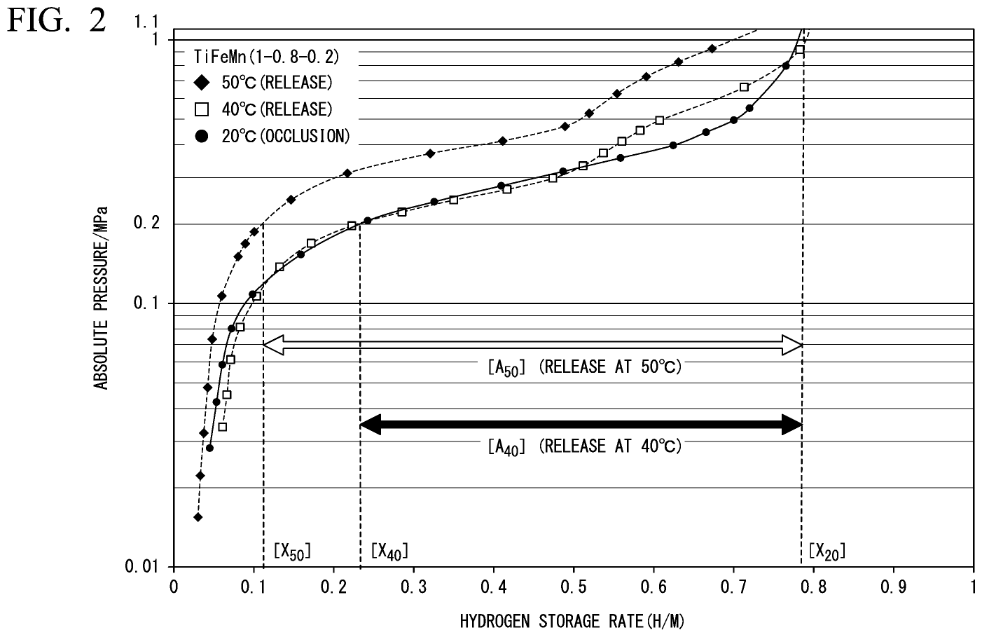

Next, the alloy ingot was coarsely pulverized and, furthermore, finely pulverized to obtain a hydrogen storage alloy of Example 1 having an average particle diameter of 0.5 mm. The PCT curve of Example 1 is shown in FIG. 2. The effective hydrogen storage rate obtained from the PCT curve of FIG. 2 is shown in Table 2.

### Example 2

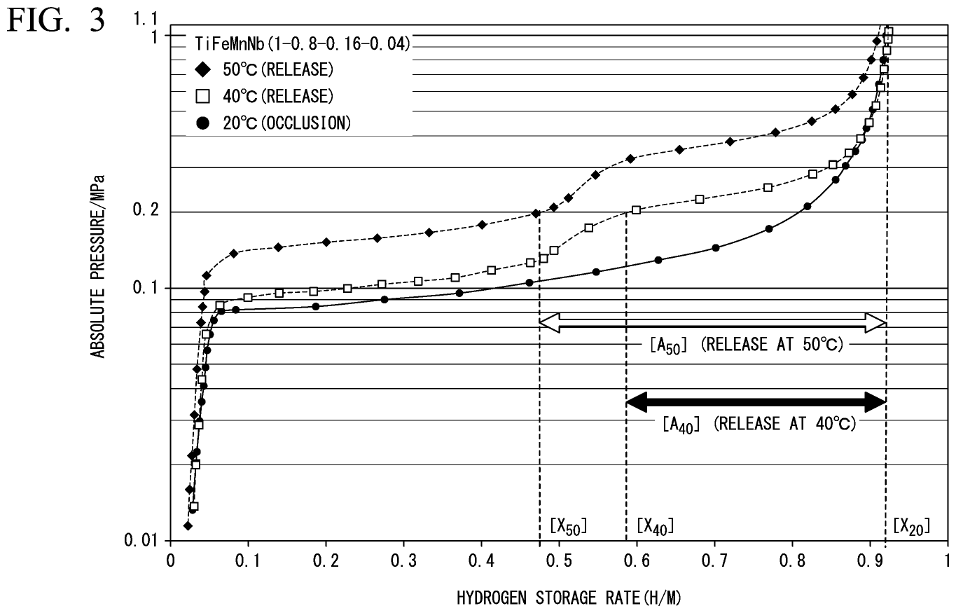

A hydrogen storage alloy of Example 2 was obtained in the same manner as in Example 1 except that metals that served as raw materials were dissolved by a high-frequency dissolution method so that the composition became TiFe_{0.80}Mn_{0.16}Nb_{0.04} in terms of the atom fraction. The PCT curve of Example 2 is shown in FIG. 3. The effective hydrogen storage rate obtained from the PCT curve of FIG. 3 is shown in Table 2.

### Example 3

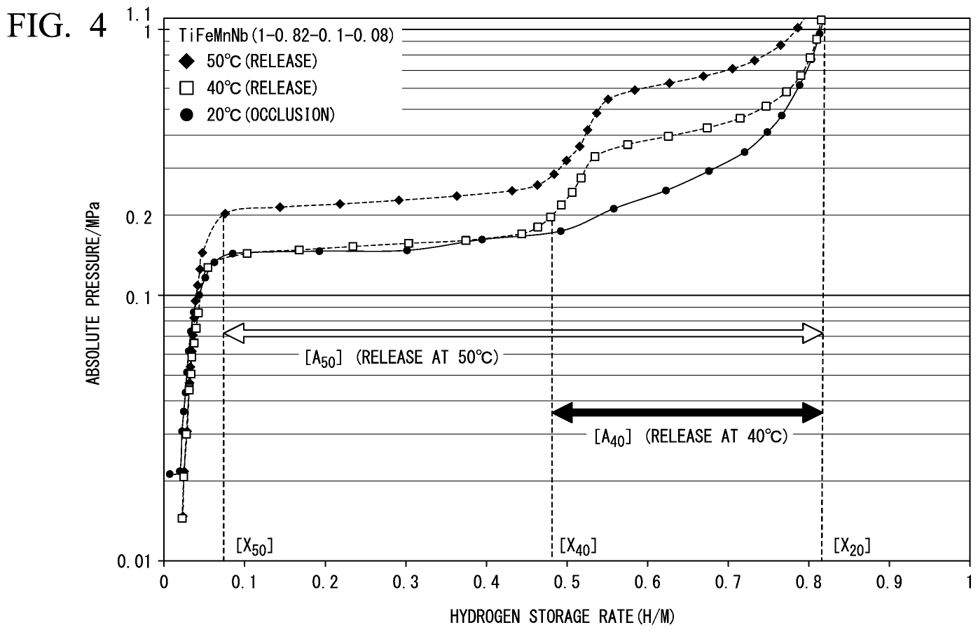

A hydrogen storage alloy of Example 3 was obtained in the same manner as in Example 1 except that metals that served as raw materials were dissolved by a high-frequency dissolution method so that the composition became TiFe_{0.82}Mn_{0.10}Nb_{0.08} in terms of the atom fraction. The PCT curve of Example 3 is shown in FIG. 4. The effective hydrogen storage rate obtained from the PCT curve of FIG. 4 is shown in Table 2.

### Example 4

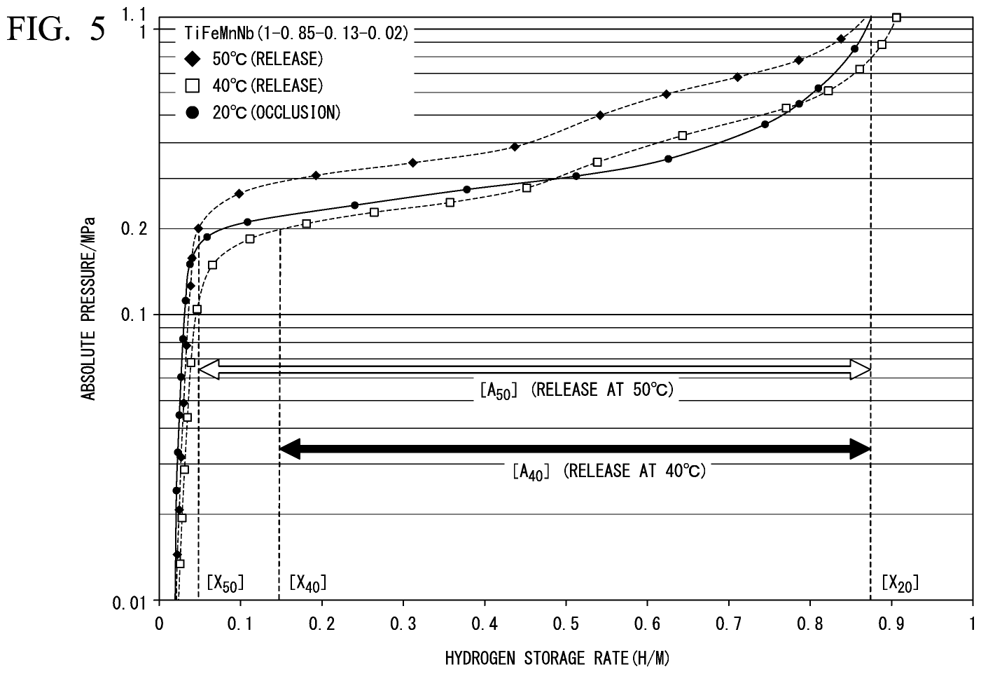

A hydrogen storage alloy of Example 4 was obtained in the same manner as in Example 1 except that metals that served as raw materials were dissolved by a high-frequency dissolution method so that the composition became TiFe_{0.85}Mn_{0.13}Nb_{0.02} in terms of the atom fraction. The PCT curve of Example 4 is shown in FIG. 5. The effective hydrogen storage rate obtained from the PCT curve of FIG. 5 is shown in Table 2.

### Example 5

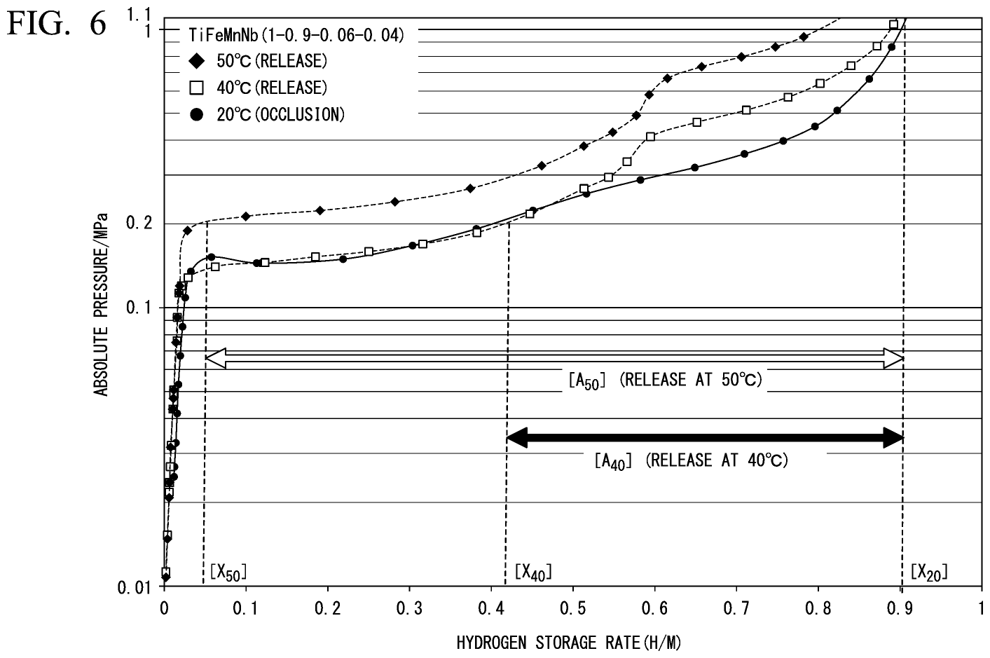

A hydrogen storage alloy of Example 5 was obtained in the same manner as in Example 1 except that metals that served as raw materials were dissolved by a high-frequency dissolution method so that the composition became TiFe_{0.90}Mn_{0.06}Nb_{0.04} in terms of the atom fraction. The PCT curve of Example 5 is shown in FIG. 6. The effective hydrogen storage rate obtained from the PCT curve of FIG. 6 is shown in Table 2.

### Example 6

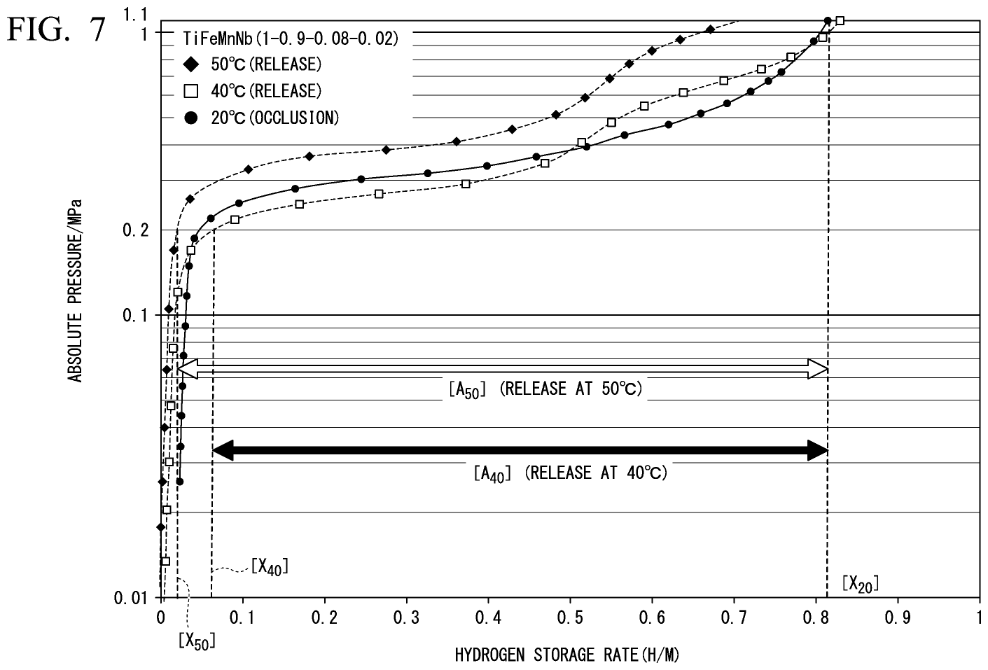

A hydrogen storage alloy of Example 6 was obtained in the same manner as in Example 1 except that metals that served as raw materials were dissolved by a high-frequency dissolution method so that the composition became TiFe_{0.90}Mn_{0.05}Nb_{0.02} in terms of the atom fraction. The PCT curve of Example 6 is shown in FIG. 7. The effective hydrogen storage rate obtained from the PCT curve of FIG. 7 is shown in Table 2.

### Example 7

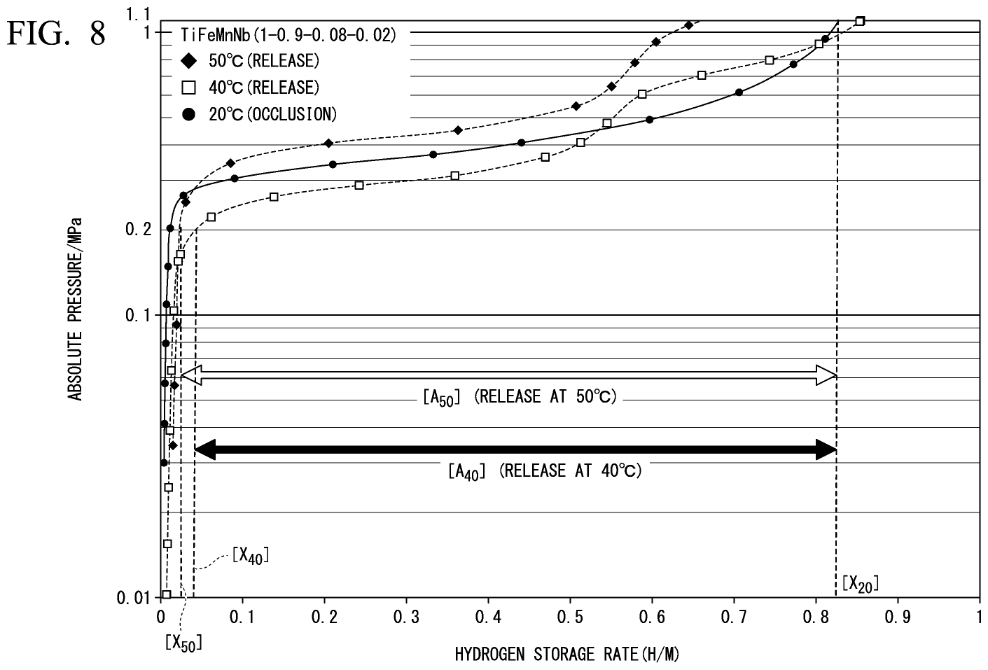

A hydrogen storage alloy of Example 7 was obtained in the same manner as in Example 1 except that metals that served as raw materials were dissolved by a high-frequency dissolution method so that the composition became TiFe_{0.95}Mn_{0.03}Nb_{0.02} in terms of the atom fraction. The PCT curve of Example 7 is shown in FIG. 8. The effective hydrogen storage rate obtained from the PCT curve of FIG. 8 is shown in Table 2.

TABLE 1

| | ELEMENT FRACTIONS UPON | | | | ELEMENT ANALYSIS RESULTS | | | | ELEMENT ANALYSIS RESULTS | | | |
|---|---|---|---|---|---|---|---|---|---|---|---|---|
| | RAW MATERIAL FORMULATION | | | | (ATOM %) | | | | (FRACTIONS) | | | |
| | Ti | Fe | Mn | Nb | Ti | Fe | Mn | Nb | Ti | Fe | Mn | Nb |
| EXAMPLE | 1 | 0.80 | 0.20 | 0.00 | 49.454 | 39.742 | 10.802 | 0 | 1 | 0.804 | 0.218 | 0 |
| 1 | | | | | | | | | | | | |
| EXAMPLE | 1 | 0.80 | 0.16 | 0.04 | — | — | — | — | — | — | — | — |
| 2 | | | | | | | | | | | | |
| EXAMPLE | 1 | 0.82 | 0.10 | 0.08 | 49.85 | 40.964 | 5.174 | 4.016 | 1 | 0.822 | 0.104 | 0.081 |
| 3 | | | | | | | | | | | | |
| EXAMPLE | 1 | 0.85 | 0.13 | 0.02 | 49.58 | 42.22 | 6.75 | 1.22 | 1 | 0.852 | 0.136 | 0.025 |
| 4 | | | | | | | | | | | | |
| EXAMPLE | 1 | 0.90 | 0.06 | 0.04 | — | — | — | — | — | — | — | — |
| 5 | | | | | | | | | | | | |
| EXAMPLE | 1 | 0.90 | 0.08 | 0.02 | — | — | — | — | — | — | — | — |
| 6 | | | | | | | | | | | | |
| EXAMPLE | 1 | 0.95 | 0.03 | 0.02 | 50.03 | 47.1 | 1.66 | 1.22 | 1 | 0.941 | 0.033 | 0.024 |
| 7 | | | | | | | | | | | | |

TABLE 2

| | | | | | | 40° C. RELEASE | 50° C. RELEASE |
|---|---|---|---|---|---|---|---|
| | 20° C. | 40° C. | 50° C. | 40° C. RELEASE | 50° C. RELEASE | EFFECTIVE | EFFECTIVE |
| | OCCLUSION | RELEASE | RELEASE | EFFECTIVE | EFFECTIVE | HYDROGEN | HYDROGEN |
| | HYDROGEN | HYDROGEN | HYDROGEN | HYDROGEN | HYDROGEN | STORAGE | STORAGE |
| | STORAGE | STORAGE | STORAGE | STORAGE | STORAGE | RATE | RATE |
| | RATE | RATE | RATE | RATE | RATE | DIFFERENCE | DIFFERENCE |
| | [X₂₀] | [X₄₀] | [X₅₀] | [A₄₀] | [A₅₀] | [ΔA₄₀] | [ΔA₅₀] |
| EXAMPLE | 0.78 | 0.23 | 0.11 | 0.55 | 0.67 | 0.00 | 0.00 |
| 1 | | | | | | | |
| EXAMPLE | 0.92 | 0.58 | 0.47 | 0.34 | 0.45 | −38.18 | −32.84 |
| 2 | | | | | | | |
| EXAMPLE | 0.82 | 0.48 | 0.07 | 0.34 | 0.75 | −38.18 | 11.94 |
| 3 | | | | | | | |
| EXAMPLE | 0.87 | 0.15 | 0.05 | 0.72 | 0.82 | 30.91 | 22.39 |
| 4 | | | | | | | |
| EXAMPLE | 0.90 | 0.42 | 0.05 | 0.48 | 0.85 | −12.73 | 26.87 |
| 5 | | | | | | | |
| EXAMPLE | 0.81 | 0.06 | 0.03 | 0.75 | 0.78 | 36.36 | 16.42 |
| 6 | | | | | | | |
| EXAMPLE | 0.82 | 0.04 | 0.03 | 0.78 | 0.79 | 41.82 | 17.91 |
| 7 | | | | | | | |

As shown in Table 2, in Examples 3 to 7, the effective hydrogen storage rates [A₅₀] in a case where the maximum temperature at the time of release was 50° C. were high. In addition, regarding Example 4, Example 6 and Example 7, the effective hydrogen storage rates [A₄₀] in a case where the maximum temperature at the time of release was 40° C. also exhibited high values.

### INDUSTRIAL APPLICABILITY

It is possible to provide a hydrogen storage alloy, a hydrogen occluding method, a hydrogen releasing method, and a power generating system that are capable of increasing the effective hydrogen storage amount.

### REFERENCE SIGNS LIST

1 Electricity supply source
2 Hydrogen production device
3 Fuel tank
4 Fuel cell
5 Electricity consumer

What is claimed is:

1. A hydrogen storage alloy having a composition represented by a general formula Ti₁FeₓMn_{y}Nb_{z} (0.804<x≤0.941, 0.033≤y≤0.136, 0<z≤0.081).

2. A hydrogen storage alloy having a composition represented by a general formula Ti₁FeₓMn_{y}Nb_{z} (0.822<x≤0.941, 0.033<y≤0.136, 0.024<z≤0.081).

3. The hydrogen storage alloy according to claim 1,
wherein, in the general formula Ti₁FeₓMn_{y}Nb_{z}, 0.8≤x+y÷z≤1.2.

4. A hydrogen occluding method,
wherein hydrogen having a hydrogen pressure of lower than 1.1 MPa (abs) is occluded into the hydrogen storage alloy according to claim 1.

5. The hydrogen occluding method according to claim 4,
wherein the hydrogen is occluded at a hydrogen storage alloy temperature of 40° C. or lower.

6. A hydrogen releasing method,
wherein hydrogen having a hydrogen pressure of 0.2 MPa (abs) or higher and lower than 1.1 MPa (abs) is released from the hydrogen storage alloy according to claim 1 occluding hydrogen at a hydrogen pressure of lower than 1.1 MPa (abs).

7. The hydrogen releasing method according to claim 6,
wherein, in response to a decrease in the hydrogen pressure in association with the hydrogen release, the hydrogen storage alloy is heated, and the hydrogen pressure is held at 0.2 MPa (abs) or higher.

8. The hydrogen releasing method according to claim 7,
wherein the hydrogen is released at a hydrogen storage alloy temperature of 40° C. or higher.

9. A power generating system comprising:
a fuel cell that generates power using hydrogen as a fuel; and
a fuel tank that supplies hydrogen to the fuel cell,
wherein the fuel tank is filled with the hydrogen storage alloy according to claim 1.

10. The power generating system according to claim 9,
wherein an output of the fuel cell is 10 kW or higher.
